(19) United States
(12) Patent Application Publication
(10) Pub. No.: US 2025/0389670 A1
(43) Pub. Date: Dec. 25, 2025

(54) DEVICE FOR DETECTING A DEFECT IN A STRUCTURAL ELEMENT MADE OF COMPOSITE MATERIAL

(71) Applicant: EPSILON COMPOSITE, GAILLAN-EN-MEDOC (FR)

(72) Inventors: Léo RICHARD, LE TAILLAN-MEDOC (FR); Lionel QUETEL, PLEUMEUR BODOU (FR); Jean-François RIBOULET, TREBEURDEN (FR); Florent LYPHOUT, CAOUENNEC-LANVEZEAC (FR)

(21) Appl. No.: 18/859,988

(22) PCT Filed: Apr. 27, 2023
(86) PCT No.: PCT/EP2023/061123

§ 371 Date: Jul. 14, 2025

(30) Foreign Application Priority Data
Apr. 28, 2022 (FR) FR2204034

(51) Int. Cl. G01N 21/88; G01N 21/84

(52) U.S. Cl. CPC G01N 21/8806; G01N 2021/8444; G01N 2021/8472; G01N 2201/06153; G01N 2201/0826

(57) ABSTRACT

The present invention relates to a device for detecting a defect in a structural element made of composite material. The device includes a structural element made of composite material and having an elongate shape, at least one detection optical fiber arranged inside the structural element, and a light-emitting device comprising a plurality of light sources connected to a strand of optical fibers, all of the strands being grouped into a bundle of strands.

The object of the present invention is a device for detecting a defect in a structural element made of composite material. In particular, the invention makes it possible to detect a rupture or incipient rupture of the structural element.

Composite structural elements are known to be used in overhead high-voltage cables. In particular, a composite ring, typically with a glass-coated carbon fiber core, can be used as a structural element. One or more layers of aluminum, in particular trapezoidal aluminum, are stranded onto the ring and act as conductors for the cable.

The choice of composite material makes the cable lighter. This means that more aluminum can be used, which limits Joule effect losses. Additionally, more current can be transmitted.

It is important to be able to check the structural integrity of the cable, and in particular the structural element of the cable.

Known, for example from document WO 2019/168998 A1, is a system for interrogating structural elements made of optical fiber-reinforced composite material to assess their structural integrity. The system and method use the transmission of light from a light-emitting device, through sensing optical fibers that are integrated along the length of the structural elements. Failure to detect light transmitted through one or more of the optical fibers is an indication that the integrity of the structural element is impaired.

The present invention provides an improved device for detecting a defect in a structural element made of composite material, the device enabling the light transmitted by a plurality of detection optical fibers to be viewed easily and successively without having to rotate the light-emitting device, while transmitting maximum light power with minimum loss.

The subject matter of the invention is thus a device for detecting a defect in a structural element made of composite material.

The device according to the invention comprises:
a structural element made of composite material and having an elongate shape,
at least one detection optical fiber arranged inside the structural element, and extending from a first longitudinal end of the structural element to a second longitudinal end of the structural element, and
a light-emitting device operatively connected to the first longitudinal end of the structural element, so as to transmit the light emitted by the light-emitting device to a first longitudinal end of said at least one detection optical fiber, the light-emitting device comprising a plurality of light sources, each light source being operatively connected to a strand of optical fibers, so as to transmit the light emitted by the light source to the optical fibers of the strand, all of the strands being grouped into a bundle of strands, notably inside a sheath arranged at one end of the strands, the end of the strands of the bundle being operatively connected with the first longitudinal end of the structural element.

In this way, the use of a bundle of strands arranged inside an alignment sheath ensures good light transmission to the structural element, with maximum transmitted power (a large amount of light is concentrated on a small section) and minimum loss. Fiber strands have the advantage that at least one fiber will be correctly aligned with a detection optical fiber.

The device can further comprise a light detection device, capable of detecting light from each detection optical fiber at a second longitudinal end of each detection optical fiber.

The light-emitting device can further be adapted to sequentially actuate the different light sources, so as to successively transmit the light emitted by the different light sources to the different strands and detection optical fibers.

With this solution, one light source can be switched on in isolation, or several light sources can be switched on simultaneously to project light onto a particular segment of the ring.

This sequential actuation feature, combined with the use of a bundle of strands at the interface between the light sources and the ring, optimizes and maintains {light source-optical fibers} alignment, guaranteeing greater reliability in assessing ring integrity. In this way, successive actuation of the various light sources enables successive illumination of each of the detection optical fibers without involving any movement of the light-emitting device, such as rotating it.

Alternatively, the light detection device can be rotated, for example, so as to successively detect light from the different detection optical fibers.

The end of the strands of the bundle is advantageously arranged inside a sheath and can be aligned with the first longitudinal end of the structural element.

The composite material may comprise a carbon fiber core surrounded by a glass layer.

The device can comprise a plurality of detection optical fibers. For example, four detection optical fibers can be used, with each fiber covering a quarter-circle in cross-section of the structural element.

The detection optical fibers may comprise at least one single-mode optical fiber and/or at least one multi-mode optical fiber. Optical detection fibers are preferably single-mode fibers, which are less expensive and smaller, reducing the risk of breakage.

The first longitudinal end and the second longitudinal end of the structural element are advantageously polished.

The plurality of light sources can comprise light-emitting diodes.

Light-emitting diodes can have an emission wavelength between 1400 and 1600 nm or between 380 and 780 nm (visible range).

The number of strands is preferably at least equal to the number of detection optical fibers.

The light detection device may comprise a photodiode.

An example of a method for implementing the device may be as follows:
the structural element is cut, for example using a hacksaw,
the first longitudinal end and the second longitudinal end of the structural element are polished,
the bundle of strands is presented facing the ring, inside the sheath,
the various light sources are switched on in succession (e.g. circularly or randomly), so that the various sectors of the bundle of strands successively illuminate the various detection optical fibers.

Further advantages and particularities of the present invention will become apparent from the following description, given as a non-limiting example and made with reference to the attached figures:

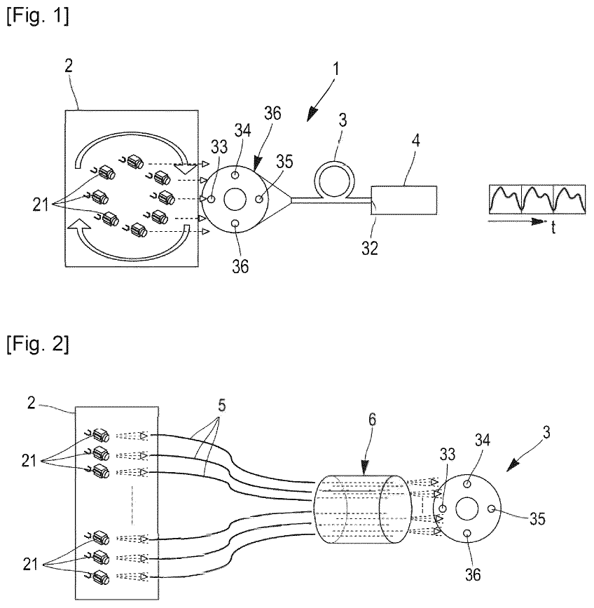

FIG. 1 is a diagram schematically showing a device for detecting a defect in a structural element made of composite material according to the invention,

FIG. 2 is a detail view of the diagram of FIG. 1,

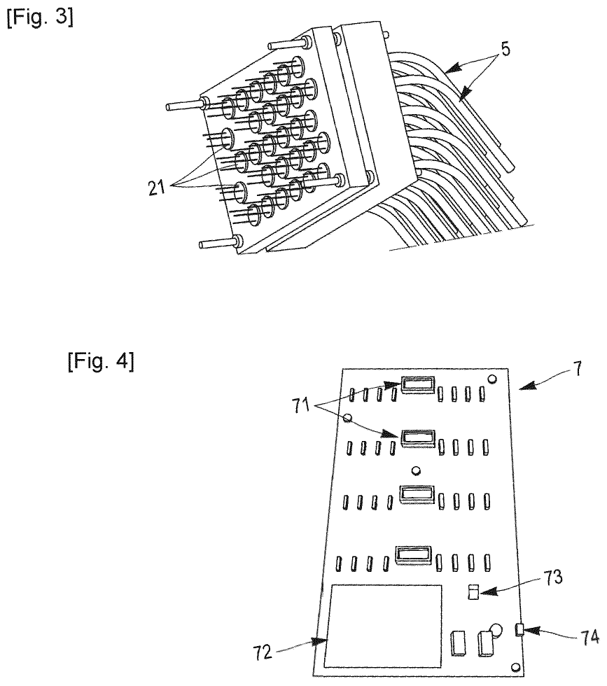

FIG. 3 is a detail view of FIG. 2,

FIG. 4 is a top view of a diode driver board,

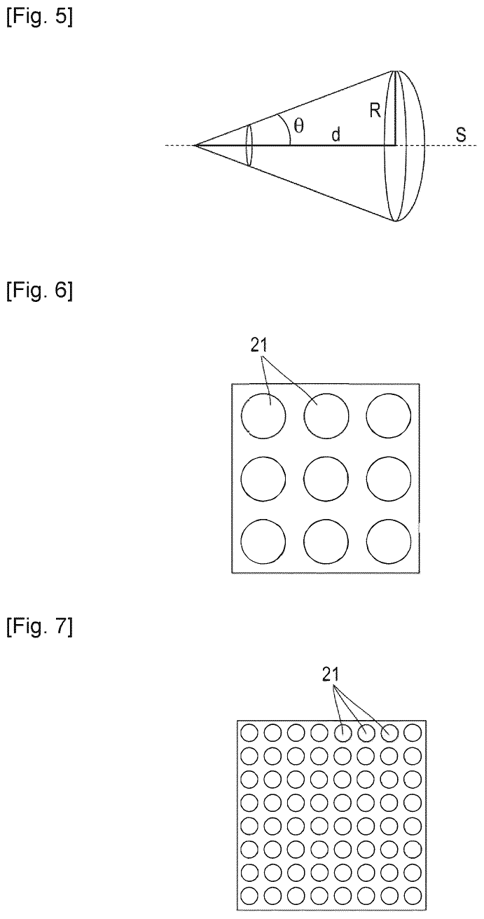

FIG. 5 is a mathematical figure useful for understanding the invention,

FIG. 6 shows a first configuration of diodes that can be used in the device according to the invention,

FIG. 7 shows a second configuration of diodes that can be used in the device according to the invention,

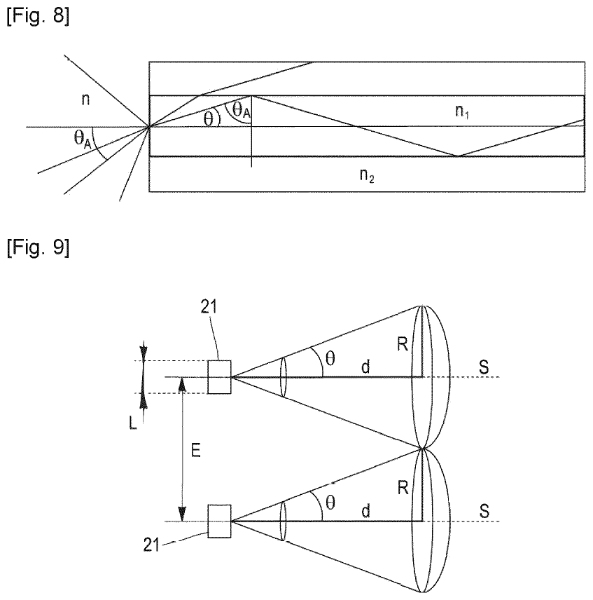

FIG. 8 is a mathematical figure useful for understanding the invention,

FIG. 9 is a mathematical figure useful for understanding the invention,

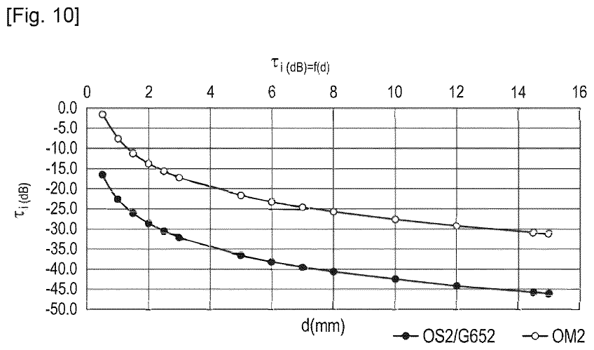

FIG. 10 is a diagram showing the loss rate as a function of the distance between the diode and the ring,

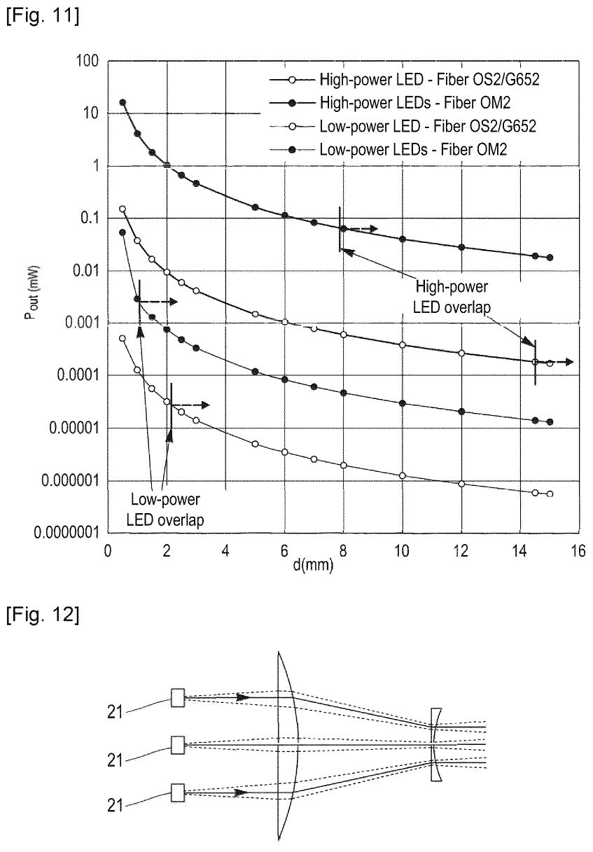

FIG. 11 is a diagram showing the power obtained at the fiber output as a function of the distance between the diode and the ring,

FIG. 12 shows the concentration of diode beams,

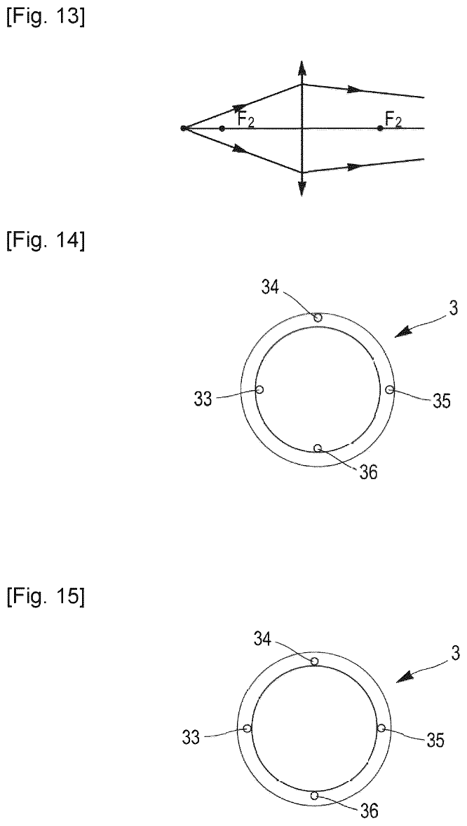

FIG. 13 shows the focusing of a divergent beam,

FIG. 14 is a cross-sectional view of a ring, according to a first embodiment,

FIG. 15 is a cross-sectional view of a ring, according to a second embodiment,

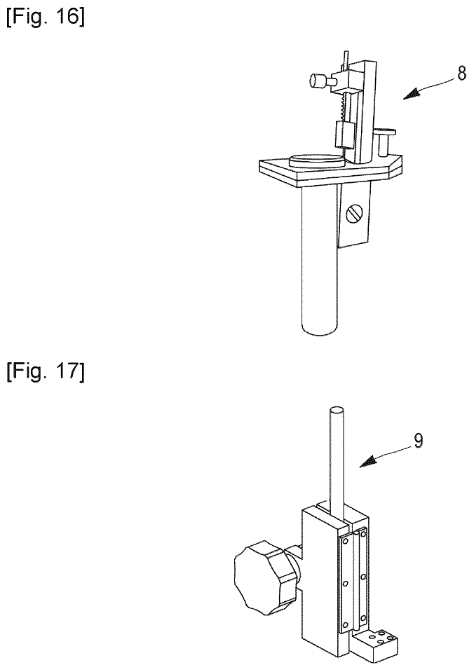

FIG. 16 is a perspective view of a polishing machine,

FIG. 17 is a perspective view of a ring holder designed to be received by the polisher shown in FIG. 16,

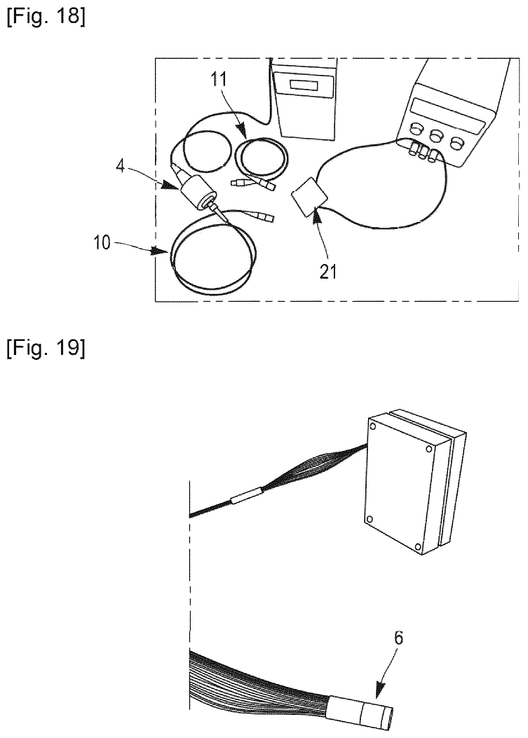

FIG. 18 is a partial perspective view of an alternative fault detection device,

FIG. 19 is a partial view of a device according to the invention,

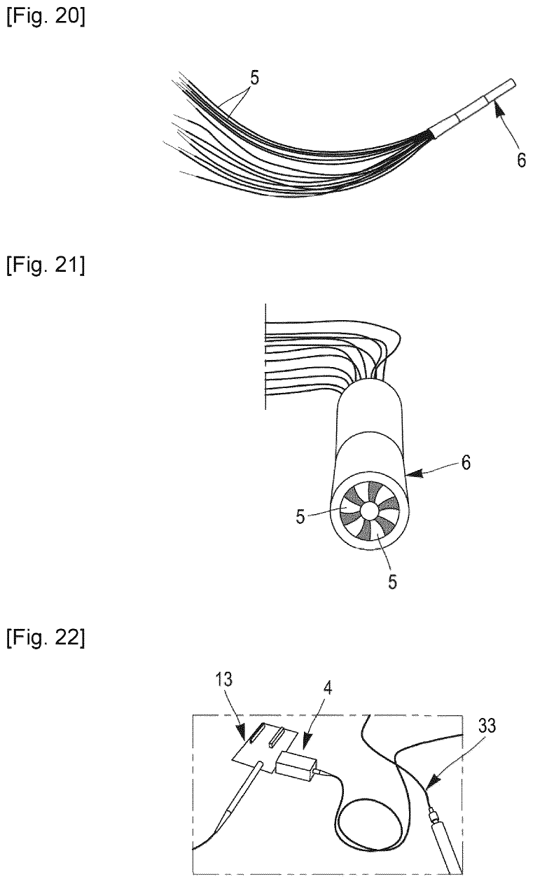

FIG. 20 is a perspective view of a set of optical fiber strands,

FIG. 21 is a detail view of the set of FIG. 20,

FIG. 22 is a perspective view of a detection device of the device according to the invention, in accordance with a first embodiment,

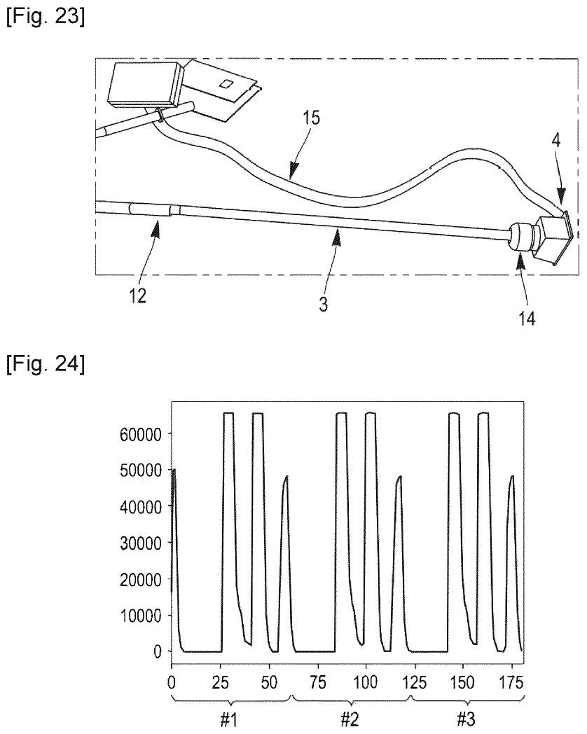

FIG. 23 is a perspective view of a detection device of the device according to the invention, in accordance with a second embodiment,

FIG. 24 is a diagram showing the level of light detection as a function of the scanning angle of the actuated light sources, according to a first embodiment,

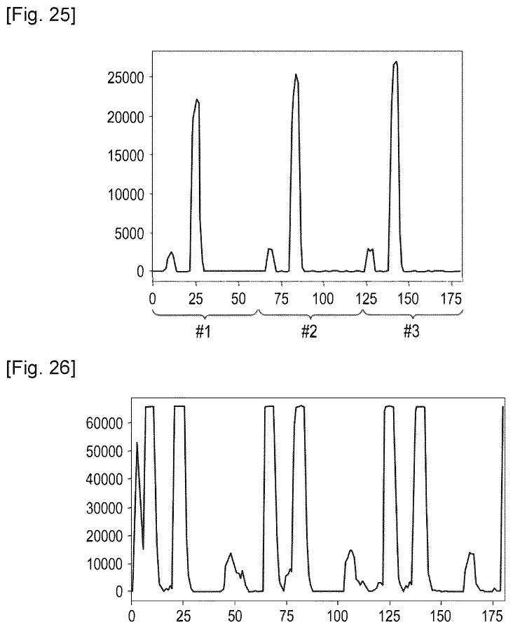

FIG. 25 is a diagram showing the level of light detection as a function of the scanning angle of the actuated light sources, according to a second embodiment,

FIG. 26 is a diagram showing the level of light detection as a function of the scanning angle of the actuated light sources, according to a third embodiment,

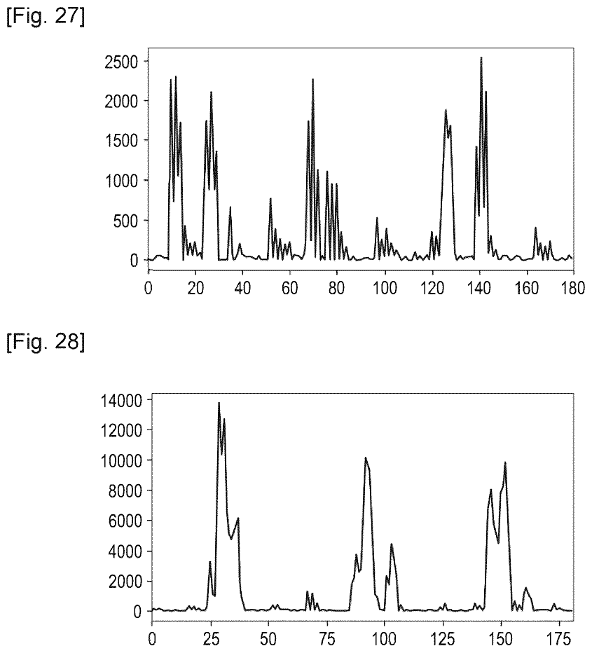

FIG. 27 is a diagram showing the level of light detection as a function of the scanning angle of the actuated light sources, according to a fourth embodiment,

FIG. 28 is a diagram showing the level of light detection as a function of the scanning angle of the actuated light sources, according to a fifth embodiment,

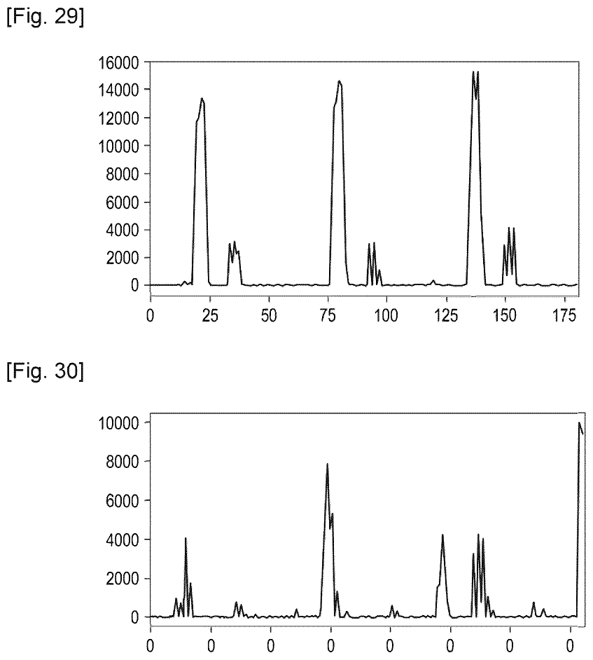

FIG. 29 is a diagram showing the level of light detection as a function of the scanning angle of the actuated light sources, according to a sixth embodiment,

FIG. 30 is a diagram showing the level of light detection as a function of the scanning angle of the actuated light sources, according to a seventh embodiment,

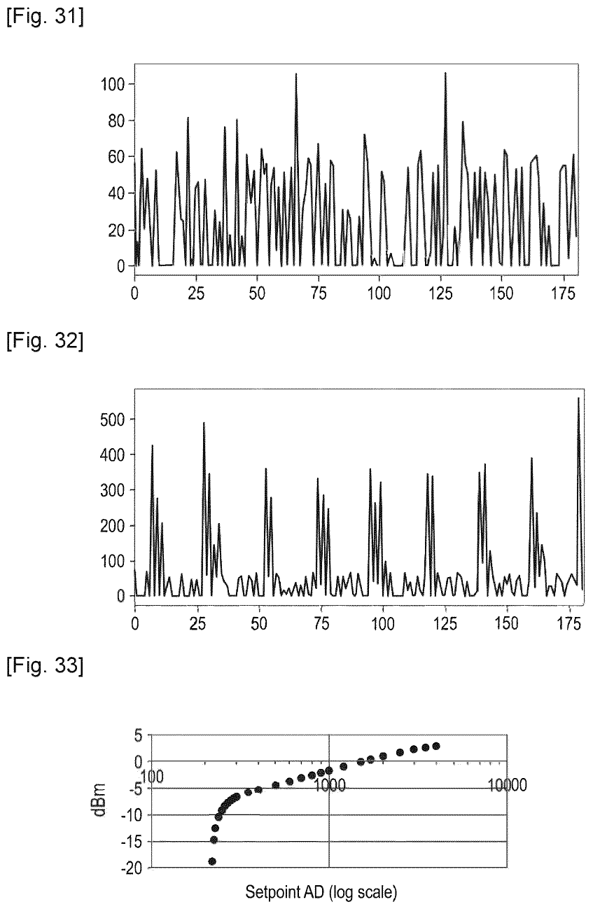

FIG. 31 is a diagram showing the level of light detection as a function of the scanning angle of the actuated light sources, according to a eighth embodiment,

FIG. 32 is a diagram showing the level of light detection as a function of the scanning angle of the actuated light sources, according to a ninth embodiment,

FIG. 33 is a diagram showing power output as a function of injection setpoint,

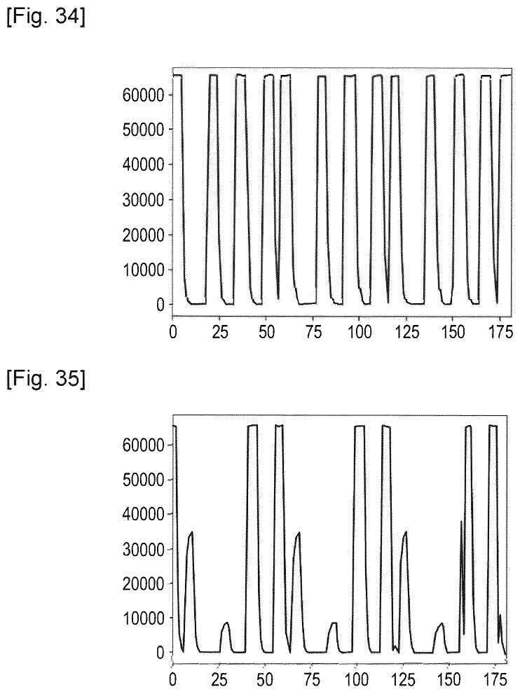

FIG. 34 is a diagram showing the level of light detection as a function of the scanning angle of the actuated light sources, according to a tenth embodiment,

FIG. 35 is a diagram showing the level of light detection as a function of the scanning angle of the actuated light sources, according to a eleventh embodiment,

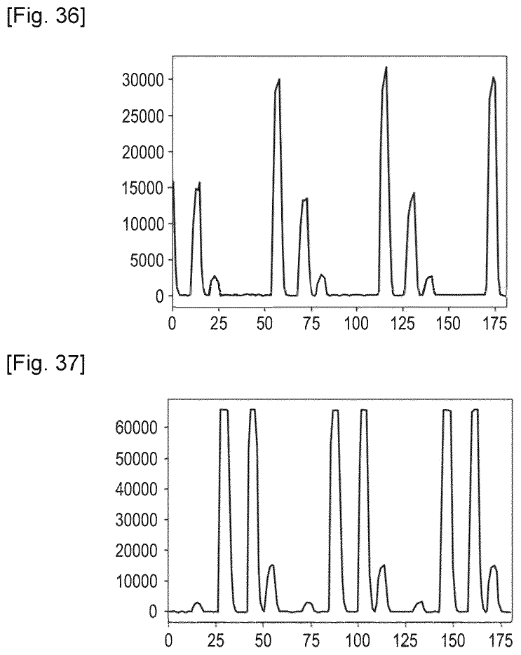

FIG. 36 is a diagram showing the level of light detection as a function of the scanning angle of the actuated light sources, according to a twelfth embodiment,

FIG. 37 is a diagram showing the level of light detection as a function of the scanning angle of the actuated light sources, according to a thirteenth embodiment,

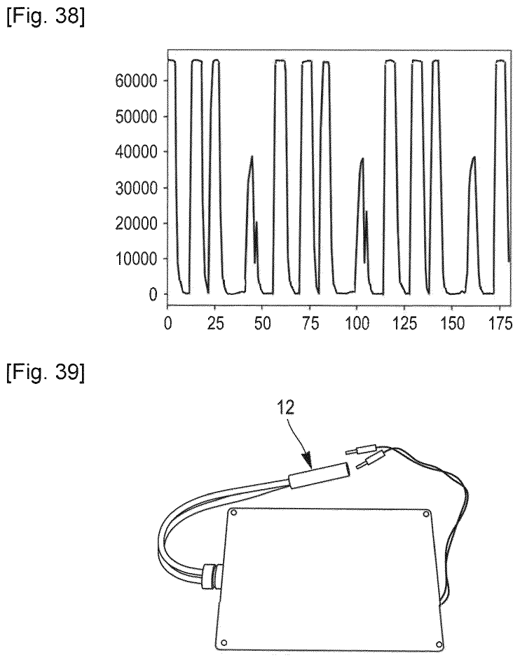

FIG. 38 is a diagram showing the level of light detection as a function of the scanning angle of the actuated light sources, according to a fourteenth embodiment,

FIG. 39 is a first partial view of a detection device according to the invention,

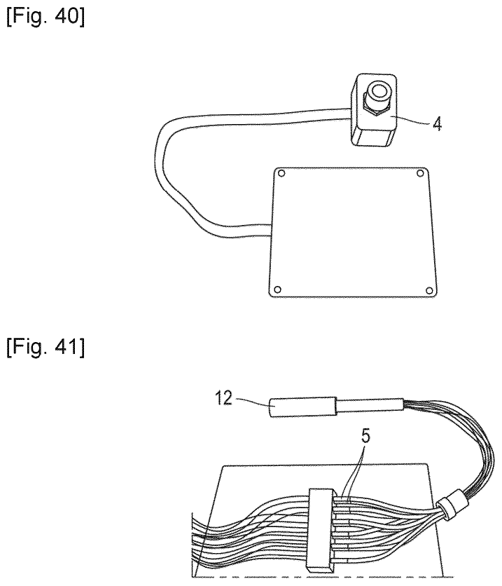

FIG. 40 is a second partial view of a detection device according to the invention,

FIG. 41 is a third partial view of a detection device according to the invention, and

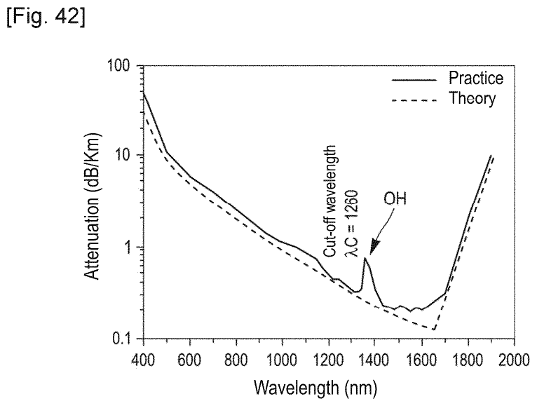

FIG. 42 is a diagram showing the absorption spectrum of optical fibers.

### DETAILED DESCRIPTION

### Operating Principle of the Detection Device According to the Invention

As shown in FIGS. 1 and 2, a device 1 for detecting a defect in a structural element made of composite material according to the invention comprises a light-emitting device 2 capable of emitting light toward a structural element 3 made of composite material, which is in the form of a ring. Light passing through the ring 3 is detected by a light detection device 4. The output of the detector 4 displays the light transmitted by the ring 3.

The light emitter 2 is able to emit optical power, part of which is injected into the optical fibers 33, 34, 35, 36 of the ring 3. The optical fibers 33, 34, 35, 36 are detection optical fibers that are arranged inside the ring 3, and extend from a first longitudinal end 31 of the ring 3 to a second longitudinal end 32 of the ring 3.

The light emitter 2 comprises a plurality of emitters 21. The emitters 21 are advantageously infrared or visible light-emitting diodes (LEDs), which are switched on in a rotating sequence to illuminate each of the fibers 33, 34, 35, 36 of the ring 3 in turn. The rotation produces a waveform at the detector 4 with as many local maxima as there are passing (undamaged) fibers.

The rotary effect should make it possible to do away with the absolute power level measured at the output of the ring 3 to conclude on the state of the fibers 33, 34, 35, 36, and thus use a criterion relative to the local maxima. The absolute power measured at the output of the ring 3 must be sufficient to obtain a quantifiable extinction by the detector 4.

The multiplicity of diodes 21 also minimizes the impact of the relative angular position between the ring 3 and the light emitter 2, since the orientation of the ring 3 in front of the diodes 21 is excluded.

As shown in FIGS. 2 and 3, each diode 21 is positioned opposite a fiber strand 5, and all the fibers of the various strands 5 are distributed within a strand bundle 6, thus capturing even more light power from each diode 21.

The bundle 6 makes it possible to multiply the number of diodes 21 without reducing light intensity. The bundle allows the diodes 21 to be moved further away from the end of the ring 3, which greatly increases the number of diodes (one diode per strand 5 of the bundle 6) and the choice of diodes, which are bulkier but have a more directional bundle (higher luminous intensity). The improved directivity of the diodes 21 thus facilitates the injection of light into the fibers of the bundle 6.

Additionally, the diodes 21 no longer need to be mechanically positioned according to the geometry of the ring 3, as this constraint is shifted to the placement of the fibers in the body of the bundle 6.

As previously mentioned, the optical fibers 33, 34, 35, 36 embedded in the ring 3 tolerate a maximum light injection angle θ_{A}. In practice, projecting light opposite the end of the ring 3, without physical connection such as welding, requires greater precision in alignment with the optical fibers 33, 34, 35, 36. A misalignment of a few degrees is enough to prevent light from effectively entering one of the optical fibers 33, 34, 35, 36 of the ring 3. As is well understood, misalignment can compromise the assessment of the material health of the composite ring 3 from the outset, as non-detection of light at the output can correspond to a false positive of structural alteration.

Multiplying the number of diodes 21 and the corresponding strands 5 of the bundle 6 according to the invention thus maximizes the chances that the light emitted by the various diodes 21 will meet this alignment condition. In other words, the light signal is statistically more likely to be adequately conveyed along the optical fibers 33, 34, 35, 36 of the ring 3 to assess its integrity.

It should therefore be noted that sequential actuation of the diodes 21, as recommended, enhances the quality of defect assessment. In fact, the rotary effect obtained by sequentially firing the diodes 21 according to the invention is not subject to the axis stability problems or vibratory behavior that can be observed in the case of a light source mechanically driven in rotation opposite the ring. Such phenomena generate deviations and therefore pollute the results.

This so-called “digital” rotation, which differs from a so-called “physical” rotation, therefore makes it possible to aim for the most precise alignment and maintain it throughout the material health assessment process. Since the device according to the invention does not rely on mechanical movement, the result is greater repeatability of results and, as a result, greater reliability. It should also be noted that the invention is not limited to generating a rotary effect by cascade actuation of the diodes 21. In practice, the diodes 21 can be operated sequentially in any pattern, or even randomly. A single diode can be switched on in isolation, or several diodes 21 can be switched on simultaneously to project light onto a particular segment of the ring 3.

This sequential actuation feature is of particular interest when damage to optical fibers 33, 34, 35, 36 seems to be detected prima facie. In fact, it is possible to multiply the passes to form a redundancy by actuating the same diodes 21, and/or adjacent diodes in the form of a cloud of points around the potential fault, several times in a row to ensure that the first detection is indeed representative of reality. Such flexibility would not be possible if a light source were moved mechanically along a predefined path, for example in a circle.

To evaluate the performance of the bundle 6, a prototype has been designed in the form of a diode 21 driver board 7 and a mechanical plate for aligning diodes 21 with the fibers of the bundle 6. The board 7 comprises diode connection terminals 71, a microcontroller socket 72, a diode current control system 73, and power supplies 74.

Comparative Test: Evaluation of Injection Losses and Linear Attenuation with a Single Transmitter

For a ring fiber, the output power level Pout will depend on the injected power Pinj and the linear attenuation in the fiber AttLin:

$$P out = Pinj - {Att}_{Lin} [ dB ]$$

And the injected power is a function of the transmitter power P_{Tx}, the power rate on the fiber core τᵢ, and the reflection rate related to the polishing quality τₚₒₗ.

The transmitter power P_{Tx} is deduced from the angular intensity I_{L} [mW·sr⁻¹] (per unit solid angle), the spherical receiving surface S and the distance d between the transmitter and the end of the fiber.

For small solid angles, the spherical surface can be approximated by the flat surface of radius R resulting from the scattering half-angle θ (FIG. 5): A first possibility (FIG. 6) is the use of high-power diodes 21 (>1000 mW·sr⁻¹), a second possibility (FIG. 7) being the use of low-power diodes 21 (5˜10 mW·sr⁻¹).

As high-power diodes, it is possible to use diodes with angular intensity equal to 1500 mW·sr⁻¹, half-angle I_{L}=50% I_{Lnom} equal to 10°, dimensions L*L*H in mm of 3.5*3.5*2.39, and angular intensity per mm² equal to 122.

As high-power diodes, it is possible to use diodes with angular intensity equal to 5 mW·sr⁻¹, half-angle/L=50% I_{Lnom} equal to 70°, dimensions L*L*H in mm of 1*0.5*0.5, and angular intensity per mm² equal to 10.

Furthermore (FIG. 8), the fiber tolerates a maximum injection angle θ_{A} characterized by its numerical aperture NA

It is possible to use a single-mode fiber with a core diameter of 9 μm, a numerical aperture of 0.12 and a maximum injection angle θ_{A} of 6.9°.

It is also possible to use a multi-mode fiber with a core diameter of 50 μm, a numerical aperture of 0.22 and a maximum injection angle θ_{A} of 12.7°.

All power with an angle of incidence greater than OA cannot be injected into the fiber (regardless of the distance between the diode and the fiber), which makes it possible to calculate P_{Tx} as a function of the diode and fiber used. Thus, for a high-power diode and a single-mode fiber, P_{Tx}=132.5 mW. For a high-power diode and multimode fiber, P_{Tx}=455.6 mW. For a low-power diode and a single-mode fiber, P_{Tx}=0.23 mW. For a low-power diode and multimode fiber, P_{Tx}=0.79 mW.

Of the power whose incidence is less than θ_{A} (P_{Tx}(θ_{A})), only a portion can actually be injected into the fiber, due to the distance between the diode and the fiber. This loss rate τᵢ can be expressed as the ratio between the surface area of the fiber core Sc and the surface area illuminated by the diode SE. The power incident on the fiber core Pᵢ(d) can be used to compare different fibers:

Considering the distance d reasonably closest to the ring (d=1 mm), the injected power as a function of diode type and fiber type is as follows:
for a high-power diode and a single-mode fiber Pᵢ(d=1 mm)=0.74 mW,
for a high-power diode and a multimode fiber P (d=1 mm)=22.78 mW,
for a low-power diode and a single-mode fiber Pᵢ(d=1 mm)=1.27 mW,
for a low-power diode and a multimode fiber Pᵢ(d=1 mm)=38.9 mW.

In the end, not all the Pᵢ(d) power will be injected due to imperfections on the core surface, despite polishing. It is difficult to predict these losses precisely, but a plausible upper bound can be considered: τₚₒₗ=3 dB.

The power actually injected into the fiber core will be progressively attenuated through the fibers, according to the linear attenuation at the working wavelength. The diodes found operate between 800 and 950 nm, corresponding to around 3.5 dB/km, that is, Att_{Lin}=7 dB for the maximum ring length of 2 km.

Comparative Test: Evaluation of Injection Losses and Linear Attenuation with Multiple Transmitters

As explained above, the aim is to achieve continuity of the power emitted at the surface of the ring by means of a diode array. This objective of continuity also means that the beams from each diode must be juxtaposed in pairs (or even overlap), which determines the diode/fiber distance d and the center distance between diodes.

Considering the exclusive two-by-two juxtaposition, the situation can be modeled as shown in FIG. 9.

For a given diode obstruction, the minimum distance to achieve beam overlap dₘᵢₙ is:

$${d}_{min} = {E}_{min} / ( {2}^{*} tan ( {θ}_{A} ) )$$

The minimum obstruction corresponds to the situation where the diodes are juxtaposed, that is, Eₘᵢₙ=L:
for a high-power diode, and for L=3.5 mm, for a single-mode fiber, dₘᵢₙ=14.5 mm,
for a high-power diode, and for L=3.5 mm, for a multimode fiber, dₘᵢₙ=7.8 mm,
for a low-power diode, and for L=0.5 mm, for a single-mode fiber, dₘᵢₙ=2.1 mm,
for a low-power diode, and for L=0.5 mm, for a multimode fiber, dₘᵢₙ=1.1 mm.

Thus, the size of the high-power diodes means that they have to be spaced apart considerably in order to achieve beam continuity, which degrades intensity by a factor squared (Ω=S/d²).

To visualize the impact of the diode/fiber distance (d), FIGS. 10 and 11 show, respectively, the power rate emitted on the fiber core τᵢ and the power level Pout at the fiber output as a function of d.

### Comparative Test: Increase in Injected Light Output

Because of their size, the high-power diodes need to be spaced apart considerably in order to achieve overlap between adjacent beams, which lowers the power density at the surface of the ring.

To compensate for this loss of density, a convergent lens could be used to position diodes on a larger diameter than that of the ring. However, the convergent lens will increase the angle of incidence of the beams at the lens periphery, preventing the beam from remaining within the fiber's numerical aperture. It would therefore be possible to add a divergent lens to restore the beam angle (FIG. 12).

Conversely, the solution based on low-power diodes is not subject to a loss of power density (the diodes being closer to the ring). However, the disadvantage of these diodes is that the angle of diffusion is much greater than the numerical aperture of the fiber.

In this case, a single convergent lens can be used to reduce the beam scattering angle to approach the numerical aperture of the fiber (FIG. 13).

### Comparative Test: Characterizing the Drum

In a first embodiment, a 250 m long, 8 mm diameter cable is supplied, instrumented with 4 optical fibers. This cable was characterized by reflectometry.
on a first multimode fiber, the wavelength is 1550 nm, the measured linear attenuation is 30 dB/km, the attenuation inhomogeneity is greater than 10 dB, the detected fiber length is 160 m, and the red pointer is detected at the 250 m exit,
on a second multimode fiber, the wavelength is 1550 nm, the measured linear attenuation is 15 dB/km, the attenuation inhomogeneity is greater than 10 dB, the detected fiber length is 250 m, and the red pointer is not detected at the 250 m exit.

These initial measurements reveal high inhomogeneity in linear attenuation, reflecting inhomogeneous stresses, and average attenuation of about 20-30 dB/km, reflecting high stresses or micro-curvatures.

These high attenuations at 1550 nm will require very high measurement dynamics.

In a second embodiment, a cable is produced by modifying the detection fiber insertion method. The fibers are more taut during the manufacturing method to even out the stresses applied between the same fibers of a ring. This 120 m cable was characterized by reflectometry.

The four detection fibers are unbroken and freely accessible at both ends. The reflectometer measurements are as follows:
for multimode fiber number 1, the wavelength is 1550 nm, the measured linear attenuation is greater than 50 dB/km, the attenuation inhomogeneity is greater than 20 dB, the detected fiber length is 130 m, and the red pointer is detected at the 130 m exit,
for multimode fiber number 2, the wavelength is 1550 nm, the measured linear attenuation is greater than 50 dB/km, the attenuation inhomogeneity is greater than 20 dB, the detected fiber length is 130 m, and the red pointer is detected at the 130 m exit,
for single-mode fiber number 1, the wavelength is 1550 nm, the measured linear attenuation is 14 dB/km, the attenuation inhomogeneity is about 3-4 dB, the detected fiber length is 130 m, and the red pointer is detected at the 130 m exit,
for single-mode fiber number 2, the wavelength is 1550 nm, the measured linear attenuation is 3 dB/km, the attenuation inhomogeneity is about 2 dB, the detected fiber length is 130 m, and the red pointer is detected at the 130 m exit.

These measurements give much better results than in the first embodiment, particularly for single-mode fibers.

Single-mode fiber number 2 shows little loss over these 120 m (less than 0.5 dB), identical to the losses of the exciting coil used. The insertion of this fiber into the ring therefore created no losses.

There are more losses on single-mode fiber number 1 (around 2 dB) and greater inhomogeneity in linear attenuation (3-4 dB). This is the result of inhomogeneous stresses or micro-curvatures on the fiber.

Both of the multimode fibers exhibit very high linear attenuation and inhomogeneity in this attenuation, reflecting high stresses or micro-bends.

These results are highly satisfactory, and encourage the use of single-mode rather than multimode fibers.

Polishing the Ring after Cutting

A polisher 8 is used (FIG. 16).

This polisher will prepare the ring ends for light injection and collection.

The model used is a polisher. Its polishing plate is large enough (5 cm in diameter) to polish rings up to 10 mm in diameter, making it easy to adapt to ring polishing. A ring holder 9 can be made to hold the ring during polishing (FIG. 17).

In order to validate the polisher's performance, a 5 m long ring was polished without prior treatment. The grain used is P180, corresponding to a very large grain size.

Experimental Results: Comparative Trial with Jumpers

An initial test was carried out using low-power diodes to evaluate the power injected into SM-single-mode jumpers 11 (and into MM-multimode jumpers 10). The two jumpers are about 50 cm long, making linear attenuation negligible.

For the SM-single-mode jumper, and with a single-mode fiber, the power measured is between 1 nW and 100 mW. For the MM-multi-mode jumper, and with a multi-mode fiber OM2, the power measured is between 100 and 100 mW.

The measured values are well below the theoretical values, by a factor of around 100. These deviations are most likely due to the fact that manual alignment of the fiber in front of the diode is not truly precise, especially as the diodes could not be soldered completely flat to the PCB due to their small size.

Experimental Results: Test with a Detection Device According to the Invention

After producing the diode control board, a prototype strand bundle was assembled from the fiber bundle to maximize the power captured from each diode, as well as the power emitted at the surface of the ring (FIG. 19).

With the plates in contact, the diode being tested is between 1 and 10 mm from the bundle entrance, preferentially between 2 and 8 mm. The output of the beam is then brought to within about 2 mm of the ring, along with a multimode fiber fitted with a factory-installed connector on one end.

When the diode is powered at its maximum current, the output power from the 200 m ring through a non-cleaved multimode fiber is between 1 nW and 100 mW, preferentially between 5 and 10 nW, and the loss between the beam output and the ring output is equivalent in power.

A prototype bundle of strands of several hundred multimode optical fibers with an outer diameter of 100 μm is built to maximize the power injected into the ring (FIG. 20). This bundle is divided into 12 sectors of around a hundred fibers each (FIG. 21). Each sector covers an angular area of 30°

### Detection System: First Version

A first version of the detection device was tested on the second drum with the invention's light-emitting device (FIG. 22).

The fibers coming out of the ring are connectorized with a factory-installed connector on one end and are connected to the light detection device 4. The light detection device can be connected to a detection printed circuit 13.

On the first single-mode fiber of the drum, the prototype detector reaches saturation at the minimum level of the reference detector. This shows that the photodiode/amplifier pair selected will a priori be sensitive enough to work below 100 mW.

After optimizing the position of the fiber in front of the beam, the power measured at the fiber output is greater than a few nW.

A test was carried out by breaking the fiber arbitrarily before injection.

In this case, no power was detected at the output without optimizing the injection (alignment of the fiber in front of the beam), which confirms the importance of the fiber surface finish, particularly on the injection side (and therefore the step of polishing the end of the ring).

The wavelength of the diode used is 650 nm, and the attenuation of the fiber at 650 nm is given as 4-5 dB/km (see FIG. 42, which shows the absorption spectrum of optical fibers marketed under the name SMF-28® by Corning). In order to characterize long cable lengths (>1-2 km), a diode will also be injected at 850 nm (attenuation of 2 dB/km).

Detection Device: Second Version (First Ring (30 cm))

The second version of the detector has been designed for easy handling in front of the ring, so it features a moving part connected to the motherboard with a flexible cable 15. The ring is 30 cm long (FIG. 23).

The end of the beam and the first longitudinal end of the ring are contained within a sheath 12. A cable gland 14 for holding the ring 3 is located at the second longitudinal end of the ring 3.

Thus, on the detector side, the ring portion has been installed in a cable gland so as to be unaffected by ambient light, thus maximizing detection dynamics.

The beam was constructed in 12 adjacent sectors.

The results are visualized using a script that formats the data from the sampling module (FIG. 24 (injection at maximum power) and FIG. 25 (injection at minimum power): the number of sequential sector ignitions is shown on the x-axis).

The test conditions are as follows: there are 10 diodes, the switch-on time for each diode is 500 ms, the sampling frequency/period is 10 Hz/100 ms, the number of rotations is 3, and the duration is 18 s.

### Detection Device: Second Version (Second Ring (120 m))

The beam-detector pairing was tested on the second ring with several levels of polishing.

To carry out the tests, the ring was cut approximately 4 m from the dry part on the injection side and 10 cm on the reception side.

In the same way as for the ring portion, the LEDs are lit in sequence, with different levels of polishing to assess its influence.

The test conditions are as follows: there are 10 diodes, each diode is switched on for 500 ms

It should be noted that the alignment between the beam and the ring input is not maintained between each test, so the absolute level cannot be accurately taken as a point of comparison between different curves. Nevertheless, the angular position remained largely unchanged during the tests.

FIG. 26 shows the case of a 15 μm input polish and a coarse output polish, with maximum diode power. Two fibers are observed in saturation.

FIG. 27 shows the case of a 15 μm input polish and a coarse output polish, with minimum diode power. The third fiber is difficult to see, as the signal-to-noise ratio is degraded.

FIG. 28 shows the case of a 15 μm input polish and a 15 μm output polish, with diode power. The 15 μm polish has improved reception. The third fiber is still difficult to distinguish.

FIG. 29 shows the case of a 6 μm input polish and a 15 μm output polish, with minimum diode power. The 6 μm input polish has significantly improved injection.

FIG. 30 shows the case of a 3 μm input polish and a 15 μm output polish, with minimum diode power. The 3 μm input polish has degraded the injection.

FIG. 31 shows the case where the LEDs are off and the ambient light is off. A minimum noise floor is observed.

FIG. 32 shows the case of polishing the diodes are off and the ambient light is on. The ring transmits ambient light.

The overall conclusions of this test phase are:
the three fibers visible to the naked eye when illuminated with a laser pointer are detectable with the beam-detection pair.

### Estimation of Injection-Detection System Dynamics

The results obtained on the portion of the first ring can be used to estimate the dynamics of the final system, and thus to assess the maximum ring length that can be achieved.

In FIGS. 24 and 25, two successive fibers (one single-mode and one multimode) are saturated at high injection power and detectable at low injection power. The setpoint value AD corresponds to the diode current setpoint, and the diode current-power characteristic is shown in FIG. 33.

Then, the detection level can drop again until it reaches a low threshold Th_{low} with a margin relative to the noise floor. The results on the 120 m ring showed that noise is induced by ambient brightness, so Th_{low} can initially be defined at 100 on a scale of 100. This gives the second element of the dynamic dyn₂, which depends on the detection level at low injection power:
for the first fiber, with a detection level at low injection power, the significant low detection threshold Th_{low} base 100, and the second element of the dynamic range dyn₂ is 250/100=2.5 or approx. 4 dB, for the second fiber, with a detection level at low injection power (25000 AD), the significant low detection threshold Thow base 100D, and the second element of the dynamic range dyn₂ is 2500/100=25, that is, approx. 14 dB.

The overall dynamic range can therefore be estimated at dyn=dyn₁+dyn₂, that is, 25.7 dB for the first fiber and 35.7 for the second.

Given the polishing, it is likely that the difference in detection between these two fibers is directly linked to the type of fiber illuminated (as linear and curvature attenuation can be neglected on a 30 cm section of ring), which would imply that the dynamic range on a single-mode fiber would be around 25 dB.

With a linear attenuation of around 5 dB per km, and assuming that fiber stresses do not induce significant additional linear attenuation, it would be possible to reach a maximum ring length of around 5 km.

### Packaging the Prototype Transceiver

FIGS. 39 to 41 show an example of a prototype detection device according to the invention.

### CONCLUSION

The tests made it possible to characterize a 130 m ring comprising two single-mode fibers and two multimode fibers.

The developed characterization system can inject and detect the signal in single-mode or multimode fibers. Proof of concept was achieved on the last ring manufactured, where four optical fibers were detected and characterized. The resulting system dynamic range is between 10 dB and 50 dB, preferentially between 25 dB and 35 dB. This dynamic makes it possible to characterize rings longer than 3 km.

Alternatively, a long ring (2-3 km) with four single-mode fibers could be used.

1. A device for detecting a defect in a structural element made of composite material, the device comprising:
a structural element made of composite material and having an elongate shape,
a plurality of detection optical fibers arranged inside the structural element, and extending from a first longitudinal end of the structural element to a second longitudinal end of the structural element, and
a light-emitting device operatively connected to the first longitudinal end of the structural element, so as to transmit the light emitted by the light-emitting device to a first longitudinal end of the detection optical fibers, wherein:
the light-emitting device comprises a plurality of light sources, each light source being operatively connected to a strand of optical fibers, so as to transmit the light emitted by the light source to the optical fibers of the strand, all the strands being grouped together in a bundle of strands, the end of the strands of the bundle being operatively connected to the first longitudinal end of the structural element,
wherein the light-emitting device is further able to successively actuate the different light sources, so as to successively transmit the light emitted by the different light sources to the different strands and detection optical fibers.

2. The device according to claim 1, wherein the device further comprises a detection light detection device, capable of detecting light from each detection optical fiber at a second longitudinal end of each detection optical fiber.

3. The device according to claim 2, wherein the light detection device is rotatable, so as to successively detect light from the various optical detection fibers.

4. The device according to claim 1, wherein the end of the strands of the bundle is arranged inside a sheath and is aligned with the first longitudinal end of the structural element.

5. The device according to claim 1, wherein the composite material comprises a carbon fiber core surrounded by a glass layer.

6. The device according to claim 1, wherein the device comprises a plurality of detection optical fibers.

7. The device according to claim 6, wherein the detection optical fibers comprise at least one single-mode optical fiber and/or at least one multimode optical fiber.

8. The device according to claim 1, wherein the first longitudinal end and the second longitudinal end of the structural element are polished.

9. The device according to claim 1, wherein the plurality of light sources comprises light-emitting diodes.

10. The device according to claim 9, wherein the light-emitting diodes have an emission wavelength between 1400 and 1600 nm or between 380 and 780 nm.

11. The device according to claim 1, wherein the number of strands is at least equal to the number of detection optical fibers.

12. The device according to claim 1, wherein the light detection device comprises a photodiode.
